(19) United States
(12) Patent Application Publication
(10) Pub. No.: US 2009/0315874 A1
(43) Pub. Date: Dec. 24, 2009

(54) Pixel and organic light emitting display device using the same

(76) Inventor: Eun-Ah Kim, Yongin-city (KR)

Correspondence Address: ROBERT E. BUSHNELL & LAW FIRM, 2029 K STREET NW, SUITE 600, WASHINGTON, DC, 20006-1004, US

(21) Appl. No.: 12/457,439

(22) Filed: Jun. 10, 2009

(30) Foreign Application Priority Data
Jun. 18, 2008 (KR) 10-2008-0057253

(51) Int. Cl. G06F 3/038; G09G 3/32

(52) U.S. Cl. 345/213; 345/82

(57) ABSTRACT

Disclosed is a pixel structure capable of reducing the rate of defective pixels. The pixel includes a plurality of organic light emitting diodes, and a plurality of light emitting control transistors respectively coupled to a plurality of the organic light emitting diodes. The light emitting control transistors are turned on at different times to supply an electric current to each of the organic light emitting diodes at different times.

### CLAIM OF PRIORITY

This application makes reference to, incorporates the same herein, and claims all benefits accruing under 35 U.S.C. §119 from an application for PIXEL AND ORGANIC LIGHT EMITTING DISPLAY DEVICE USING THE SAME earlier filed in the Korean Intellectual Property Office on the 18 of Jun. 2008 and there duly assigned Serial No. 10-2008-0057253.

### BACKGROUND OF THE INVENTION

1. Field of the Invention

The present invention relates to a pixel and an organic light emitting display device using the same, and more particularly to a pixel structure capable of reducing numbers of defective pixels, and an organic light emitting display device using the same.

2. Description of the Related Art

An organic light emitting display device uses an organic light emitting diode to display an image. Such an organic light emitting display device has attracted attention as a next-generation flat panel display since it can be produced in a light and thin display device.

The organic light emitting diode is a spontaneous light emitting element that includes an anode electrode, a cathode electrode, and an organic light emitting layer interposed between the anode electrode and the cathode electrode. Therefore, the organic light emitting diode shows excellent physical and optical properties such as luminance and color purity.

However, the organic light emitting layer generally includes thin films. Therefore, short may easily occur between the anode electrode and the cathode electrode of the organic light emitting diode due to fine particles having a size of several thousands Angstrom (A) and presented in the thin films.

As described above, when the short occurs in the organic light emitting diode, pixels including such an organic light emitting diode are out of control and does not emit light, so that these defective pixels are recognized as dark spots by users.

### SUMMARY OF THE INVENTION

Accordingly, the present invention is designed to solve such drawbacks described above, and therefore an object of the present invention is to provide a pixel capable of reducing defective pixels, and an organic light emitting display device using the same.

One embodiment of the present invention is achieved by providing a pixel including a plurality of organic light emitting diodes, and a plurality of light emitting control transistors respectively coupled to the plurality of the organic light emitting diodes. The light emitting control transistors are turned on at different times to supply an electric current to each of a plurality of the organic light emitting diodes at different times.

At least one of the light emitting control transistors may be a different type transistor from the rest of the plurality of the light emitting control transistors. Gate electrodes of the light emitting control transistors are commonly coupled to a light emitting control line that alternately supplies at least two voltage levels during one horizontal period.

The light emitting control transistors may be the same type transistors. A gate electrode of at least one of the light emitting control transistors is coupled to a different light emitting control line from light emitting control lines coupled to the rest of the plurality of the light emitting control transistors. The light emitting control lines supplies voltage levels at different times from each other.

The pixel according to the present invention may further include a switching transistor receiving a data signal from a data line when a scan signal is supplied from a scan line, a capacitor storing the data signal supplied from the switching transistor, and a drive transistor supplying an electric current to the plurality of the light emitting control transistors. An amount of the electric current depends on a magnitude of the data signal.

Another embodiment of the present invention is achieved by providing an organic light emitting display device including a scan driver outputting a scan signal and a light emitting control signal into scan lines and light emitting control lines, respectively, and a pixel unit including a plurality of pixels coupled to the scan lines, the light emitting control lines and data lines. Each of the pixels includes a plurality of organic light emitting diodes, and a plurality of light emitting control transistors respectively coupled to the plurality of the organic light emitting diodes. The light emitting control transistors are turned on at different times to supply an electric current to each of a plurality of the organic light emitting diodes at different times.

At least one of the light emitting control transistors included in one of the pixels may be a different type transistor from the rest of the plurality of the light emitting control transistors included in the one of the pixels. Gate electrodes of the light emitting control transistors are commonly coupled to the same light emitting control line. The light emitting control signal alternately supplies at least two voltage levels during one horizontal period.

The light emitting control transistors included in one of the pixels may be the same type transistors. A gate electrode of at least one of the light emitting control transistors is coupled to a different light emitting control line from light emitting control lines coupled to the rest of the plurality of the light emitting control transistors. The scan driver alternately outputs the light emitting control signal to the different light emitting control lines during one horizontal period.

As described above, the pixel according to the present invention includes a plurality of the organic light emitting diodes coupled respectively to a plurality of the light emitting control transistors to supply an electric current at different times. Therefore, although short occurs in some organic light emitting diodes included in the pixels, the poor pixels may be alleviated by the light emission of the other organic light emitting diodes. Therefore, it is possible to prevent the entire pixels from being recognized as dark spots by a user.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a view showing an organic light emitting display device according to one exemplary embodiment of the present invention.

FIG. 2 is a circuit diagram showing a pixel according to one exemplary embodiment of the present invention.

FIG. 3 is a waveform view showing a method of driving the pixel as shown in FIG. 2.

FIG. 4 is a circuit diagram showing a pixel according to another exemplary embodiment of the present invention.

FIG. 5 is a waveform view showing a method of driving the pixel as shown in FIG. 4.

### DETAILED DESCRIPTION OF THE INVENTION

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, some of the elements that are not essential to the complete understanding of the invention are omitted for clarity. Also, like reference numerals refer to like elements throughout.

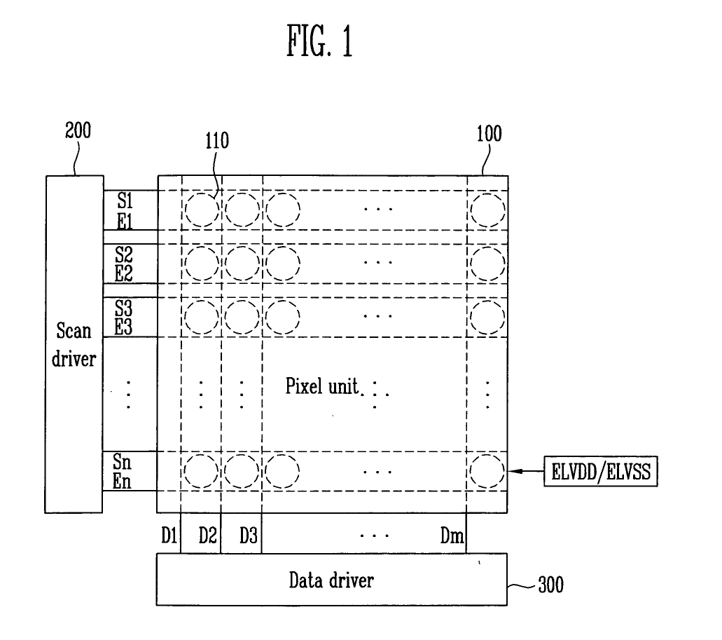

FIG. 1 is a view showing an organic light emitting display device according to one exemplary embodiment of the present invention. Referring to FIG. 1, the organic light emitting display device according to one exemplary embodiment of the present invention includes a pixel unit 100, a scan driver 200, and a data driver 300.

The pixel unit 100 includes a plurality of pixels 110 arranged in intersection portions of scan lines S1 to Sn, light emitting control lines E1 to En, and data lines D1 to Dm.

Each of the pixels 110 is coupled to the scan line S and the light emitting control line E arranged in a row in which each of the pixels 110 is disposed; and the data line D arranged in a column in which each of the pixels 110 is disposed. Each of the pixels 110 emits light responding to a scan signal, a light emitting control signal and a data signal, which are supplied respectively from the scan line S, the light emitting control line E and the data line D that are coupled to each of the pixels 110. Therefore, an image is displayed in the pixel unit 100 through the light emission from the pixels 110.

Meanwhile, the pixel unit 100 receives first and second pixel powers ELVDD and ELVSS from external sources (for example, a power supply unit). Such first and second pixel powers ELVDD and ELVSS are transmitted to each of the pixels 110 and used as a driving power source of the pixels 110.

The scan driver 200 sequentially generates a scan signal and a light emitting control signal to correspond to externally supplied scan control signals. The scan signal and the light emitting control signal generated in the scan driver 200 are outputted respectively into the scan lines S1 to Sn and the light emitting control lines E1 to En, and then transmitted to the pixels 110.

According to the present invention, the scan driver 200 supplies a light emitting control signal to the light emitting control lines E1 to En during one horizontal period, the light emitting control signal being able to alternately turn on a plurality of light emitting control transistors not shown included in the pixels 110. This context of the scan driver 200 will be described later in more detail.

The data driver 300 generates a data signal to correspond to the data and the data control signal supplied from the outside environments. The data signal generated in the data driver 300 is outputted into the data lines D1 to Dm, and then transmitted to the pixels 110.

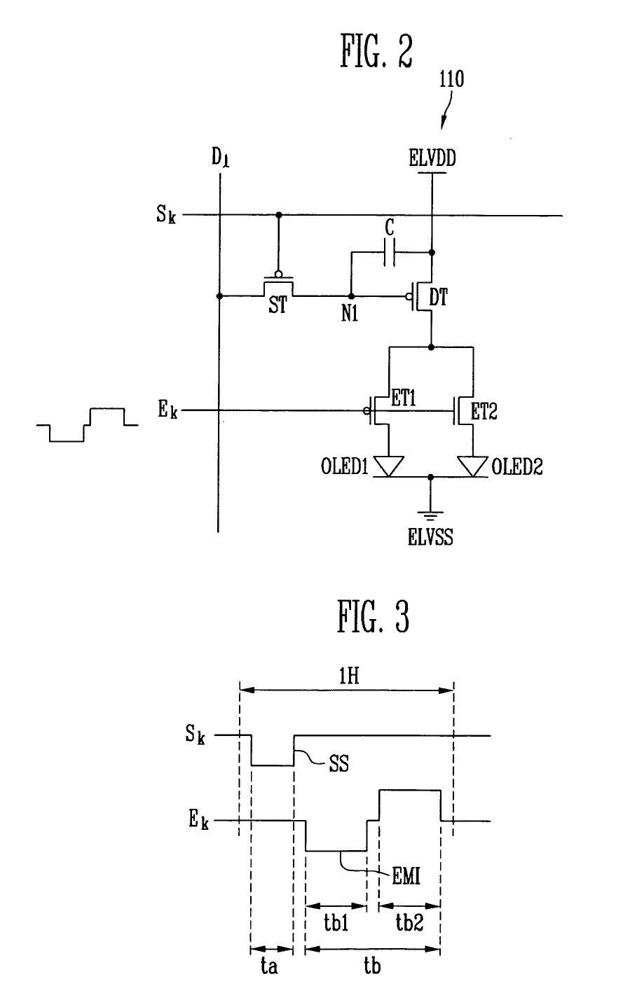

FIG. 2 is a circuit diagram showing a pixel according to one exemplary embodiment of the present invention. Here, the pixel as shown in FIG. 2 may apply to the organic light emitting display device as shown in FIG. 1, etc.

Referring to FIG. 2, the pixel 110 includes a switching transistor ST, a capacitor C, a drive transistor DT, a plurality of light emitting control transistors ET1 and ET2, and a plurality of organic light emitting diodes OLED1 and OLED2 coupled respectively to a plurality of the light emitting control transistors ET1 and ET2.

The switching transistor ST is coupled between a data line D1 and the first node N1, and a gate electrode of the switching transistor ST is coupled to a scan line Sk. Here, the first node N1 is a node to which one electrode (for example, drain electrode) of the switching transistor ST, one electrode of the capacitor C and a gate electrode of the drive transistor DT are commonly coupled. Such a switching transistor ST is turned on when a LOW level of a scan signal is supplied to the scan line Sk, and thus transmits a data signal supplied from the data line D1 to the inner part (first node N1) of the pixel 110.

The capacitor C is coupled between the first node N1 and the first pixel power ELVDD. Such a capacitor C stores a data signal when a scan signal is supplied to the scan line Sk. The data signal is supplied to the first node N1 via the switching transistor ST. The capacitor C maintains the stored data signal during one frame period.

The drive transistor DT is coupled between the first pixel power ELVDD and a plurality of the light emitting control transistors ET1 and ET2, and a gate electrode of the drive transistor DT is coupled to the first node N1. Such a drive transistor DT supplies an electric current to a plurality of light emitting control transistors ET1 and ET2. The electric current has a capacity corresponding to the data signal.

A plurality of the light emitting control transistors ET1 and ET2 are coupled in parallel between the drive transistor DT and the second pixel power ELVSS. And, the organic light emitting diodes OLED1 and OLED2 are coupled between a plurality of the light emitting control transistors ET1 and ET2 and the second pixel power ELVSS, respectively.

That is to say, according to the present invention, one pixel 110 includes a plurality of organic light emitting diodes OLED1 and OLED2, and a plurality of light emitting control transistors ET1 and ET2 coupled respectively to a plurality of the organic light emitting diodes OLED1 and OLED2. A plurality of the organic light emitting diodes OLED1 and OLED2 coupled respectively to a plurality of the light emitting control transistors ET1 and ET2 and a plurality of the light emitting control transistors ET1 and ET2 are coupled in parallel between the drive transistor DT and the second pixel power ELVSS.

For convenience' sake, FIG. 1 shows that two light emitting control transistors ET1 and ET2 and two organic light emitting diodes OLED1 and OLED2 are coupled to each other in the pixel 110.

Here, the light emitting control transistors ET1 and ET2 and the organic light emitting diodes OLED1 and OLED2 are referred to as first and second light emitting control transistors ET1 and ET2 and first and second organic light emitting diodes OLED1 and OLED2, respectively.

In this case, the first light emitting control transistor ET1, the first organic light emitting diode OLED1 coupled in series to the first light emitting control transistor ET1, the second light emitting control transistor ET2 and the second organic light emitting diode OLED2 coupled in series to the second light emitting control transistor ET2 are coupled in parallel to each other.

However, the first light emitting control transistor ET1 and the second light emitting control transistor ET2 are set to different-type transistors. For example, when the first light emitting control transistor ET1 is set to a P-type transistor, the second light emitting control transistor ET2 may be set to an N-type transistor.

Also, these gate electrodes are commonly coupled to the same one light emitting control line Ek to which a first voltage (LOW voltage level) and a second voltage (HIGH voltage level) are alternately supplied during a light emitting period of the one horizontal period. Here, the first voltage is set to a voltage level that may turn on the first light emitting control transistor ET1. The second voltage is set to a voltage level that may turn on the second light emitting control transistor ET2.

That is to say, the first and second light emitting control transistors ET1 and ET2 are turned on at different times by the light emitting control signal to which the first voltage and the second voltage are alternately supplied during the light emitting period of the one horizontal period.

Therefore, the first and second organic light emitting diodes OLED1 and OLED2 receives an electric current from the first and second light emitting control transistors ET1 and ET2 at different times, respectively, and are then allowed to emit light. Here, each of the first and second organic light emitting diodes OLED1 and OLED2 preferably includes an organic light emitting layer emitting light with the same color since the first and second organic light emitting diodes OLED1 and OLED2 are included in one pixel 110. For example, first and second organic light emitting diodes OLED1 and OLED2 included in a red pixel includes an organic light emitting layer emitting red light.

Hereinafter, a method of driving the pixel 110 as shown in FIG. 3 will be described in more detail with reference to the waveform view showing a driving method of the pixel as shown in FIG. 2.

Referring to FIG. 3, a LOW level of a scan signal SS is supplied to a scan line Sk during a scan period ta of one horizontal period 1H. Accordingly, a switching transistor ST is turned on, and therefore a data signal supplied from a data line D1 is transmitted to a first node N1. Then, the data signal transmitted to the first node N1 is stored in a capacitor C.

Then, a light emitting control signal EMI, which is alternately set to a first voltage (LOW voltage level) and a second voltage (HIGH voltage level), is supplied to a light emitting control line Ek during a light emitting period tb, which is set after the scan period ta. In this case, the scan driver 200, as shown in FIG. 1, outputs the light emitting control signal EMI that is alternately set to a first voltage and a second voltage during the light emitting period tb of the one horizontal period 1H.

When a LOW voltage level of the light emitting control signal EMI is supplied to the light emitting control line Ek during a first period tb1 of the light emitting period tb, the first light emitting control transistor ET1 is turned on. Then, a current path is formed between the first pixel power ELVDD and the second pixel power ELVSS via the drive transistor DT, the first light emitting control transistor ET1 and the first organic light emitting diode OLED1. The amount of electric current flowing through the electric current path is determined according to a magnitude of a voltage supplied to a gate electrode of the drive transistor DT, that is, the amount of the data signal stored in the capacitor C. The first organic light emitting diode OLED1 emits light with luminance corresponding to the current capacity supplied to the first organic light emitting diode OLED1 during the first period tb1 of the light emitting period tb. However, the first organic light emitting diode OLED1 may not emit light when a data signal corresponding to a black grey level is supplied to the first organic light emitting diode OLED1.

Then, when a HIGH voltage level of the light emitting control signal EMI is supplied to the light emitting control line Ek during a second period tb2 of the light emitting period tb, the second light emitting control transistor ET2 is turned on. Then, a current path is formed between the first pixel power ELVDD and the second pixel power ELVSS via the drive transistor DT, the second light emitting control transistor ET2 and the second organic light emitting diode OLED2. Then, the second organic light emitting diode OLED2 emits light with luminance corresponding to the current capacity supplied to the second organic light emitting diode OLED2.

Meanwhile, FIG. 2 shows only two light emitting control transistors ET1 and ET2 that are set to different-type transistors, but the present invention is not particularly limited thereto. For example, it is apparent that one pixel 110 includes two P-type light emitting control transistors and two N-type light emitting control transistors. Also, FIG. 3 shows that the light emitting control signal EMI that is set once to a first voltage and a second voltage is supplied to the light emitting control line Ek during the light emitting period tb of the one horizontal period 1H. However, it is possible to change the light emitting control signal EMI to alternately supply the first voltage and the second voltage according to the number and types of the light emitting control transistors.

As described above, according to the present invention, the first and second organic light emitting diodes OLED1 and OLED2 emit light at different times since the first and second light emitting control transistors ET1 and ET2 are turned on at different times. That is to say, the first and second organic light emitting diodes OLED1 and OLED2 alternately emit light during different periods of the light emitting period tb of the one horizontal period 1 H.

Therefore, even though some organic light emitting diodes (namely, first or second organic light emitting diodes OLED1 or OLED2) included in one of the pixels 110 do not emit the light due to short-circuit during a corresponding light emitting period, the other organic light emitting diodes emit light during other light emitting period. Therefore, although a pixel is defective due to a defective organic light emitting diode (the first or second organic light emitting diode OLED1 or OLED2), the pixel including the defective organic light emitting diode still works. Therefore, it is possible to prevent the defective pixel from being recognized as a dark spot by a user.

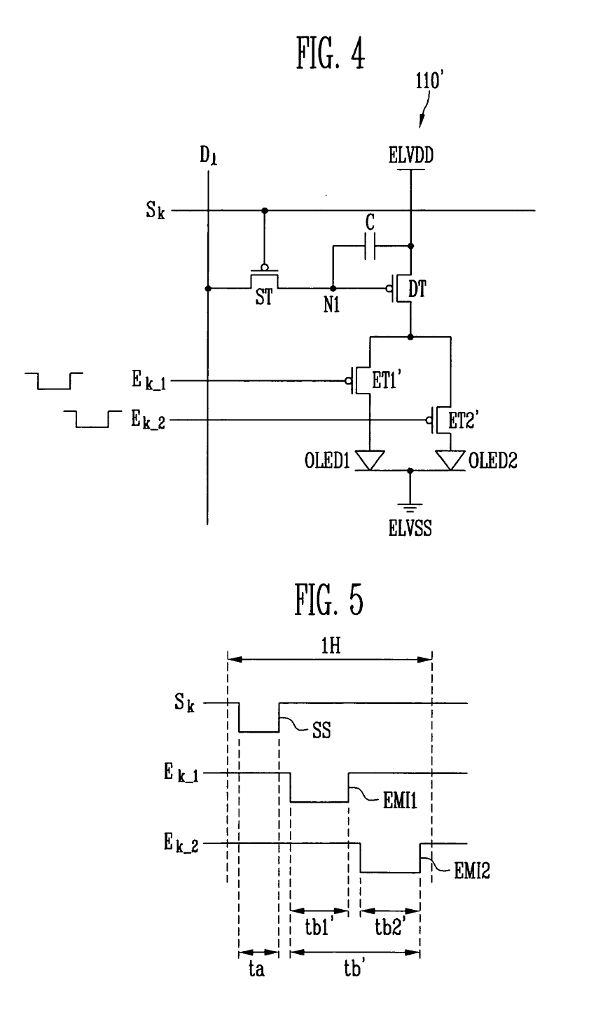

FIG. 4 is a circuit diagram showing a pixel according to another exemplary embodiment of the present invention. FIG. 5 is a waveform view showing a driving method of the pixel as shown in FIG. 4. In FIGS. 4 and 5, the same parts as in FIGS. 2 and 3 have the same reference numerals, and their detailed descriptions are omitted for clarity.

Referring to FIGS. 4 and 5, first and second light emitting control transistors ET1′ and ET2′ are all set to P-type transistors. However, gate electrodes of the first and second light emitting control transistors ET1′ and ET2′ are coupled to first and second light emitting control lines Ek_1 and Ek_2, respectively, to which a light emitting control signal is supplied at different times.

For example, the first light emitting control transistor ET1′ may be coupled to the first light emitting control line Ek_1 to which a LOW voltage level of the first light emitting control signal EMI1 is supplied during a first period tb1′ of the light emitting period tb′. The second light emitting control transistor ET2′ may be coupled to the second light emitting control line Ek_2 to which a LOW voltage level of the second light emitting control signal EMI2 is supplied during a second period tb2′ of the light emitting period tb′.

In this case, the pixel 110′ as shown in FIG. 4 may be driven in the same manner as the pixel 110 as shown in FIG. 2, for example, by having the first and second organic light emitting diodes OLED1 and OLED2 alternately emit light during a light emitting period tb′. Therefore, detailed description of the pixel 110′ is omitted for clarity.

Meanwhile, FIG. 4 shows only two light emitting control transistors ET1′ and ET2′, but the present invention is not particularly limited thereto. For example, it is apparent that one pixel 110′ may include at least three P-type light emitting control transistors whose gate electrodes are coupled to the light emitting control lines Ek to which light emitting control signals are supplied at different times.

Also, FIG. 4 shows that the light emitting control transistors ET1′ and ET2′ are all set to P-type transistors, but the present invention is not particularly limited thereto. For example, all the light emitting control transistors ET1′ and ET2′ may be also set to N-type transistors. In this case, a HIGH voltage level of the light emitting control signals EMI1 and EMI2 may be alternately supplied to the light emitting control lines Ek_1 and Ek_2 during the light emitting period tb′.

That is to say, according to this exemplary embodiment of the present invention, a plurality of the light emitting control transistors ET1′ and ET2′ are set to the same-type transistors whose gate electrodes are coupled to the different light emitting control lines Ek_1 and Ek_2 to which the light emitting control signals EMI1 and EMI2 are supplied at different times.

As described above, like the pixel 110 as shown in FIG. 1, the pixel 110′ as shown in FIG. 4 also allow the organic light emitting diodes OLED1 and OLED2 to alternately emit light using the light emitting control transistors ET1′0 and ET2′ that are turned on at different times. Therefore, it is possible to reduce a number of defective pixels.

Meanwhile, the pixel 110′ as shown in FIG. 4 may apply to the organic light emitting display device as shown in FIG. 1, etc. In this case, each of the light emitting control lines E as shown in FIG. 1 may be composed of two light emitting control lines Ek_1 and Ek_2. The scan driver 200 as shown in FIG. 1 may alternately output the first and second light emitting control signals EMI1 and EMI2 into the two light emitting control lines Ek_1 and Ek_2 during the one horizontal period 1H.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A pixel for a display device, comprising:
a plurality of organic light emitting diodes; and
a plurality of light emitting control transistors respectively coupled to the plurality of the organic light emitting diodes, the light emitting control transistors being turned on at different times to supply an electric current to each of the organic light emitting diodes at different times.

2. The pixel according to claim 1, wherein at least one of the light emitting control transistors is a different type transistor from the rest of the plurality of the light emitting control transistors, gate electrodes of the light emitting control transistors being commonly coupled to a light emitting control line that alternately supplies at least two voltage levels during one horizontal period.

3. The pixel according to claim 1, wherein the light emitting control transistors are the same type transistors, a gate electrode of at least one of the light emitting control transistors being coupled to a different light emitting control line from light emitting control lines coupled to the rest of the plurality of the light emitting control transistors, the light emitting control lines supplying voltage levels at different times from each other.

4. The pixel according to claim 1, further comprising:
a switching transistor receiving a data signal from a data line when a scan signal is supplied from a scan line;
a capacitor storing the data signal supplied from the switching transistor; and
a drive transistor supplying an electric current to the plurality of the light emitting control transistors, an amount of the electric current depending on a magnitude of the data signal.

5. The pixel according to claim 4, wherein:
the switching transistor is coupled between the data line and a first node, a gate electrode of the switching transistor being coupled to the scan line, the capacitor is coupled between the first node and a first pixel power,
the drive transistor is coupled between the first pixel power source and the plurality of the light emitting control transistors, a gate electrode of the drive transistor being coupled to the first node, and
the light emitting control transistors and the organic light emitting diodes respectively coupled to the light emitting control transistors are arranged in parallel between the drive transistor and a second pixel power.

6. The pixel according to claim 1, wherein each of the organic light emitting diodes comprises an organic light emitting layer for emitting light, the organic light emitting diodes emitting light with the same color.

7. An organic light emitting display device, comprising:
a scan driver outputting a scan signal and a light emitting control signal into scan lines and light emitting control lines, respectively; and
a pixel unit including a plurality of pixels coupled to the scan lines, the light emitting control lines and data lines, each of the pixels comprising:
a plurality of organic light emitting diodes; and
a plurality of light emitting control transistors respectively coupled to the plurality of the organic light emitting diodes, the light emitting control transistors being turned on at different times to supply an electric current to each of the organic light emitting diodes at different times.

8. The organic light emitting display device according to claim 7, wherein at least one of the light emitting control transistors included in one of the pixels is a different type transistor from the rest of the plurality of the light emitting control transistors included in the one of the pixels, gate electrodes of the light emitting control transistors are commonly coupled to the same light emitting control line.

9. The organic light emitting display device according to claim 8, wherein the light emitting control signal alternately supplies at least two voltage levels during one horizontal period.

10. The organic light emitting display device according to claim 7, wherein the light emitting control transistors included in one of the pixels are the same type transistors, a gate electrode of at least one of the light emitting control transistors being coupled to a different light emitting control line from light emitting control lines coupled to the rest of the plurality of the light emitting control transistors.

11. The organic light emitting display device according to claim 10, wherein the scan driver alternately outputs the light emitting control signal to the different light emitting control lines during one horizontal period.

12. The organic light emitting display device according to claim 7, wherein each of the organic light emitting diodes included in one of the pixels comprises an organic light emitting layer for emitting light, the organic light emitting diodes emitting light with the same color.
